(19) United States
(12) Patent Application Publication
(10) Pub. No.: US 2026/0033474 A1
(43) Pub. Date: Feb. 5, 2026

(54) FIXING STRUCTURE FOR LINE SLACK PREVENTION AND SPINNING REEL

(71) Applicant: Shimano Inc., Osaka (JP)

(72) Inventors: Takafumi TSUJI, Osaka (JP); Koji OCHIAI, Osaka (JP)

(21) Appl. No.: 19/239,049

(22) Filed: Jun. 16, 2025

(30) Foreign Application Priority Data
Jul. 31, 2024 (JP) 2024-124335

(51) Int. Cl. A01K 89/01

(52) U.S. Cl. CPC A01K 89/01082

(57) ABSTRACT

A fixing structure for line slack prevention to be disposed on a bail support member of a spinning reel for fishing, the fixing structure includes a line slack prevention member having a cylindrical mounting portion to be inserted into a mounting hole on the bail support member and a fin portion extending radially outward from the mounting portion, and an expanding member to be inserted in a through-hole in the mounting portion of the line slack prevention member to fix the mounting portion of the line slack prevention member to the bail support member in an expanded state.

### CROSS-REFERENCE TO RELATED APPLICATIONS

This application claims priority to Japanese Patent Application No. 2024-124335, filed on Jul. 31, 2024. The entire disclosure of Japanese Patent Application No. 2024-124335 is hereby incorporated by reference.

### BACKGROUND

### Technical Field

The present disclosure generally relates to a fixing structure for line slack prevention provided on a bail support member of a spinning reel for fishing, and a spinning reel for fishing.

### Background Information

In a conventionally known spinning reel for fishing (for example, Japanese Laid Open Patent Application No. 2021-087419), the spinning reel comprises a spool around which a fishing line is wound, a rotor having a rotor arm that winds the fishing line around this spool, a bail support member that is attached to the rotor arm of this rotor so as to be freely turnable, a line roller that is provided on this bail support member and guides the fishing line to the spool, and a fin (line slack prevention member) that is detachably mounted on the bail support member.

### SUMMARY

In the spinning reel for fishing described above, the line slack prevention member has a substantially C-shaped arm portion for mounting the line slack prevention member on the bail support member by embracing a portion of the bail support member, but in order to mount the line slack prevention member on the bail support member, the arm portion must be opened to mount onto the bail support member, and thus there is room for improvement in terms of ease of mounting the line slack prevention member on the bail support member.

In addition, in the case of a large (strong) spinning reel for fishing intended for large fish, the bail support part is sometimes made of metal rather than resin. At this time, there is the risk that the mounting of the line slack prevention member on the bail support part becomes too strong, making it difficult to attach and detach. In addition, if fixing and mounting are carried out using screws, or the like, there is the risk of electrolytic corrosion between different metals or corrosion due to salt water, etc., making it impossible to remove, so there is room for improvement.

Therefore, the present disclosure is intended to solve the problems of the prior art described above, and an object of the present disclosure is to provide a fixing structure for line slack prevention that fixes a line slack prevention member to a bail support member with a simple structure, and a spinning reel for fishing.

The first aspect of the disclosure is a fixing structure for line slack prevention provided on a bail support member of a spinning reel for fishing, and solves the above-mentioned problem by the fixing structure comprising a line slack prevention member having a cylindrical mounting portion inserted into a mounting hole provided on the bail support member and a fin portion that extends radially outward from the mounting portion, and an expanding member that is inserted into a through-hole provided on the mounting portion of the line slack prevention member to fix the mounting portion of the line slack prevention member to the bail support member in an expanded state.

According to the fixing structure for line slack prevention of the first aspect of the disclosure, the fixing structure comprises an expanding member that is inserted into a through-hole provided on the mounting portion of the line slack prevention member to fix the mounting portion of the line slack prevention member to the bail support member in an expanded state, so that when the expanding member is inserted into the through-hole of the line slack prevention member, the mounting portion of the line slack prevention member expands in diameter and is pressed against the bail support member; therefore, the line slack prevention member can be fixed to the bail support member with a simple structure.

In addition to the configuration of the fixing structure for line slack prevention of the first aspect of the disclosure, the second aspect of the disclosure further solves the above-mentioned problem as a result of male threads being formed on the outer circumferential surface of the expanding member, and female threads that screw onto the male threads of the expanding member being formed on the inner circumferential surface of the through-hole of the line slack prevention member.

According to the fixing structure for line slack prevention of the second aspect of the disclosure, in addition to the effect exhibited by the fixing structure for line slack prevention of the first aspect of the disclosure, as a result of female threads that screw onto the male threads of the expanding member being formed on the inner circumferential surface of the through-hole of the line slack prevention member, it is possible to provide a expanding member that is unlikely to fall off the line slack prevention member.

That is, as a result of the female threads, which screw onto the male threads of the expanding member, and which are formed on the inner circumferential surface of the through-hole of the line slack prevention member, when the expanding member is screwed into the mounting portion of the line slack prevention member, the expanding member is inserted into the mounting portion of the line slack prevention member. Therefore, when the expanding member is inserted into the mounting portion of the line slack prevention member, the expanding member and the mounting portion of the line slack prevention member screw onto each other, making it difficult for the expanding member to fall off the line slack prevention member.

In addition to the configuration of the fixing structure for line slack prevention of the first or second aspects of the disclosure, the third aspect of the disclosure further solves the above-mentioned problem as a result of the line slack prevention member being made of resin and being elastically deformable.

According to the fixing structure for line slack prevention of the third aspect of the disclosure, in addition to the effect exhibited by the fixing structure for line slack prevention of the first or second aspect of the disclosure, as a result of the line slack prevention member being made of resin and being elastically deformable, it is possible to suppress or prevent damage to the line slack prevention member caused by a knot, etc., in the fishing line forcefully contacting the distal end portion of the fin portion of the line slack prevention member.

That is, because the line slack prevention member is made of resin and can be elastically deformed, when a knot, etc., in the fishing line passes between the line roller and the distal end portion of the fin portion of the line slack prevention member, the fin portion of the line slack prevention member is pushed by the knot, etc., and is able to swing freely together with the knot, etc., in the direction in which the fishing line is guided, thereby suppressing or preventing damage to the line slack prevention member caused by a knot, etc., in the fishing line forcefully contacting the distal end portion of the fin portion of the line slack prevention member.

In addition to the configuration of the fixing structure for line slack prevention of any one of the first to the third aspects of the disclosure, the fourth aspect of the disclosure further solves the above-mentioned problem since the mounting portion of the line slack prevention member has an abutting part that is inserted into and abuts against the mounting hole of the bail support member, and a diameter expanding part that has a larger diameter than the abutting part, the diameter expanding part protrudes from the mounting hole of the bail support member, and is further on the distal end side than the abutting part.

According to the fixing structure for line slack prevention of the fourth aspect of the disclosure, in addition to the effect exhibited by the fixing structure for line slack prevention of any one of the first to the third aspects of the disclosure, since the mounting portion of the line slack prevention member has an abutting part that is inserted into and abuts against the mounting hole of the bail support member, and a diameter expanding part with a larger diameter than the abutting part, and the diameter expanding part protrudes from the mounting hole of the bail support member, and is further on the distal end side than the abutting part, the expanding member is unlikely to fall off when inserted into the mounting portion of the line slack prevention member.

That is, since the mounting portion of the line slack prevention member having an abutting part that is inserted into and abuts against the mounting hole of the bail support member, and a diameter expanding part that has a larger diameter than the abutting part, and the diameter expanding part protrudes from the mounting hole of the bail support member, and is further on the distal end side than the abutting part, the diameter expanding part of the mounting portion of the line slack prevention member functions as a stopper. As can be understood, the diameter expanding part is inserted into the mounting hole of the bail support member in a state of having a reduced diameter due to the diameter expanding part's own elasticity, Therefore, it is the expanding member is unlikely to fall off when inserted into the mounting portion of the line slack prevention member.

The fifth aspect of the disclosure solves the above-mentioned problem by comprising a spool for winding a fishing line, a rotor having a rotor arm that winds the fishing line onto the spool, a bail support member that turns with free up-and-down movement relative to the rotor arm of the rotor, a line roller that is provided on the bail support member and guides the fishing line to the spool, a line slack prevention member having a cylindrical mounting portion inserted into a mounting hole provided on the bail support member and a fin portion that extends radially outward from the mounting and faces the line roller, and an expanding member that is inserted into a through-hole provided on the mounting portion of the line slack prevention member to expand the diameter of the mounting portion of the line slack prevention member and fixing the mounting portion to the bail support member.

According to a spinning reel for fishing of the fifth aspect of the disclosure, the spinning reel comprises a expanding member that is inserted into a through-hole provided in the mounting portion of the line slack prevention member to expand the diameter of the mounting portion of the line slack prevention member to fixing the line slack prevention member to the bail support member, by causing the mounting portion of the line slack prevention member to expand in diameter and press against the bail support member. Therefore, the line slack prevention member can be fixed to the bail support member with a simple structure.

According to the present disclosure, the line slack prevention member can be fixed to the bail support member with a simple structure.

### BRIEF DESCRIPTION OF THE DRAWINGS

FIG. 1 is a left side view of a spinning reel 100 for fishing according to a first embodiment of the present disclosure.

FIG. 2 is a front view of the spinning reel 100 for fishing shown in FIG. 1.

FIG. 3 is an enlarged view of the main part of the spinning reel 100 for fishing shown in FIG. 2 as viewed from the III direction.

FIG. 4 is a cross-section diagram taken along line IV-IV shown in FIG. 3.

FIG. 5 is a cross-section diagram of a line slack prevention member 170 taken along the V-V section of FIG. 4.

FIG. 6 is an exploded view of a fixing structure of the line slack prevention member 170 shown in FIG. 4.

FIG. 7 is a cross-section diagram of a line slack prevention member 270 provided in a spinning reel 200 for fishing according to a second embodiment of the present disclosure.

FIG. 8 is a cross-section diagram explaining a fixing structure of the line slack prevention member 270 in the spinning reel 200 for fishing according to the second embodiment of the present disclosure.

### DETAILED DESCRIPTION

Any specific embodiment of the fixing structure for line slack prevention of the present disclosure can be used, as long as the fixing structure is a fixing structure for line slack prevention provided on a bail support member of a spinning reel for fishing. The fixing structure comprises a line slack prevention member having a cylindrical mounting portion inserted into a mounting hole provided on the bail support member and a fin portion that extends radially outward from the mounting portion, and an expanding member that is inserted into a through-hole provided on the mounting portion of the line slack prevention member to fix the mounting portion of the line slack prevention member to the bail support member in an expanded state. Accordingly, the line slack prevention member can be fixed to the bail support member with a simple structure.

In addition, any specific embodiment of the spinning reel for fishing of the present disclosure can be used, as long as the spinning reel comprises a spool for winding a fishing line, a rotor having a rotor arm that winds the fishing line onto the spool, a bail support member that turns with free up-and-down movement relative to the rotor arm of the rotor, a line roller that is provided on the bail support member and guides the fishing line to the spool, a line slack prevention member having a cylindrical mounting portion inserted into a mounting hole provided on the bail support member and a fin portion that extends radially outward from the mounting portion and faces the line roller, and an expanding member that is inserted into a through-hole provided on the mounting portion of the line slack prevention member to expand the diameter of the mounting portion of the line slack prevention member and fixing the mounting portion to the bail support member, whereby the line slack prevention member can be fixed to the bail support member with a simple structure.

For example, any material can be used for the line slack prevention member as long as the diameter of the mounting portion can be expanded with the expanding member, but the material is preferably resin that has sufficient elasticity so as to be elastic deformable.

For example, the expanding member can be any member that is formed of a member that is harder than the line slack prevention member.

For example, since the bail support member forms the external appearance of the spinning reel, from the viewpoint of improving the aesthetics and the viewpoint of deformation, damage, etc., when the spinning reel is dropped, it is preferable to use a member having about the same hardness as metal on the surface or to apply a surface treatment such that the surface has about the same hardness as metal, but there is no particular limitation on the material of the bail support member or the surface treatment to be applied to the surface of the bail support member

### Embodiment 1

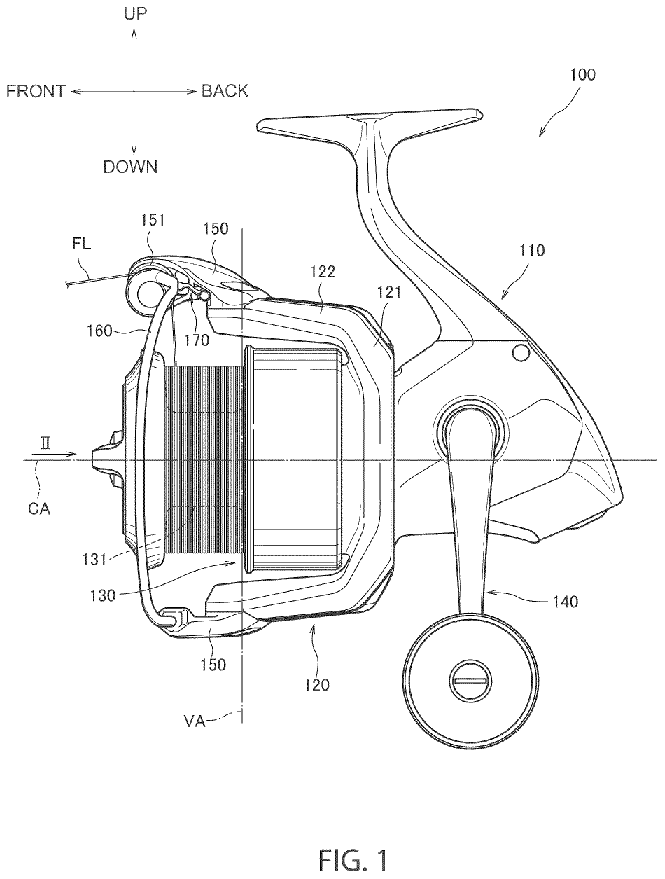

A spinning reel 100 for fishing according to a first embodiment of the present disclosure, and a fixing structure for line slack prevention incorporated into this spinning reel 100 for fishing will be described below, with reference to FIGS. 1 to 6.

### 1. Basic Structure of Spinning Reel

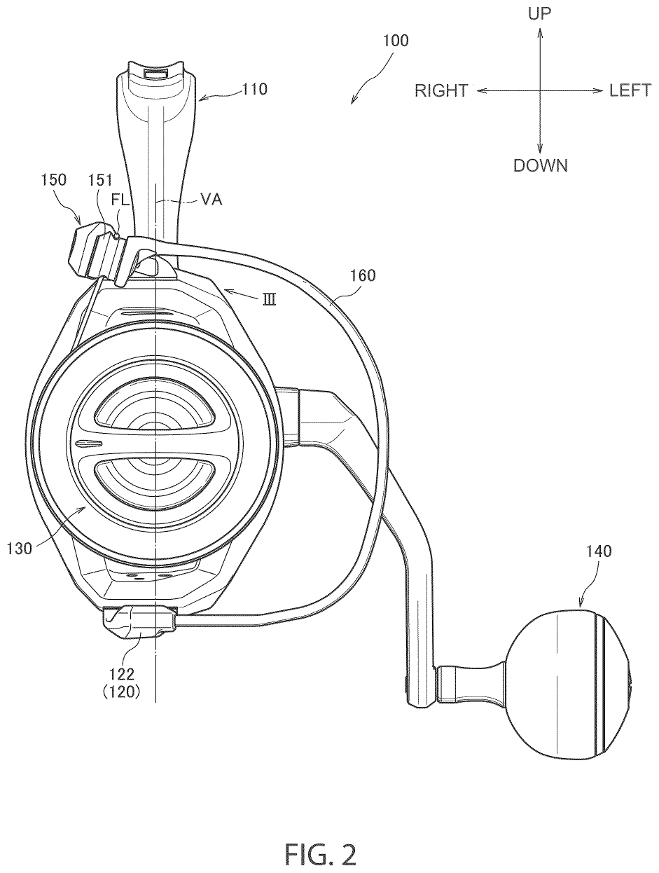

First, the basic structure of the spinning reel 100 will be described with reference to FIGS. 1 and 2.

FIG. 1 is a left side view of the spinning reel 100 according to the first embodiment of the present disclosure, and FIG. 2 is a front view of the spinning reel 100 shown in FIG. 1.

As shown in FIGS. 1 and 2, the spinning reel 100 is an open-face spinning reel and comprises a reel body 110 that is attached to a fishing rod (not shown), a rotor 120 that is attached to the front side of the reel body 110 and that is rotatable relative to the reel body 110, a spool 130 that is detachably mounted on a spool shaft (not shown) that extends forward from the reel body 110 and is configured to wind a fishing line FL, a handle 140 that is attached to a side surface of the rear side of the reel body 110, a bail support member 150 that is attached to the tip of the rotor 120, and a bail 160 that is attached to this bail support member 150.

The reel body 110 has an internal space, and this internal space of the reel body 110 is provided with a rotor drive mechanism for rotating the rotor 120 and an oscillating mechanism for moving the spool shaft back and forth together with the spool 130.

The rotor 120 can rotate freely relative to the reel body 110 about a spool axis CA extending in the front-rear direction.

In addition, the rotor 120 has an annular reel mounting portion 121 that is mounted on the reel body 110, and an arm portion (rotor arm) 122 that extends forward from the outer circumferential end of the reel mounting portion 121 and that winds the fishing line FL onto the spool 130 and is spaced apart from and faces the spool 130.

The spool 130 is a cylindrical member and has a bobbin trunk 131 around the outer periphery of which the fishing line FL is wound.

The handle 140 is connected to the oscillating mechanism and the rotor drive mechanism in the reel body 110.

Accordingly, when a user of the spinning reel 100 rotates the handle 140, the rotor 120 rotates about the spool axis CA and moves the spool shaft back and forth in reciprocating fashion, thereby moving in the front-rear direction of the spool 130 in reciprocating fashion.

The fishing line FL is thereby evenly wound onto the bobbin trunk 131 of the spool 130.

The bail support member 150 is pivotably attached to the tip of the arm portion 122 of the rotor 120.

The bail support member 150 that is configured in this manner turns pivotably and with free up-and-down movement relative to the arm portion 122 of the rotor 120 about a bail rotation axis VA that extends in the up-down direction (direction perpendicular to the direction in which the arm portion 122 extends) shown in FIG. 1, between a winding position in which the fishing line FL is wound onto the spool 130 and a release position in which the fishing line FL is released from the spool 130.

In FIGS. 1 and 2, the bail support member 150 is in the winding position.

In addition, a line roller 151 that guides the fishing line FL to the spool 130 is attached to one side of the bail support member 150.

The bail 160 is a member obtained by bending a wire material into a U-shape, and is provided so as to guide the fishing line FL to the line roller 151 when the bail support member 150 is in the winding position.

In addition, when releasing the fishing line FL, the user of the spinning reel 100 holds the bail 160 and changes, to the release position, the position of the bail support member 150 relative to the arm portion 122 of the rotor 120.

### 2. Line Slack Prevention Member and Fixing Structure for Line Slack Prevention Member.

The spinning reel 100 for fishing further comprises a line slack prevention member 170 that prevents line slack that occurs as a result of the fishing line FL coming off of the line roller 151 and the tension of the fishing line FL relaxing, when the fishing line FL is being guided by the line roller 151 to the spool 130.

Therefore, the fixing structure of this line slack prevention member 170 will be described next, with reference to FIGS. 1 to 6.

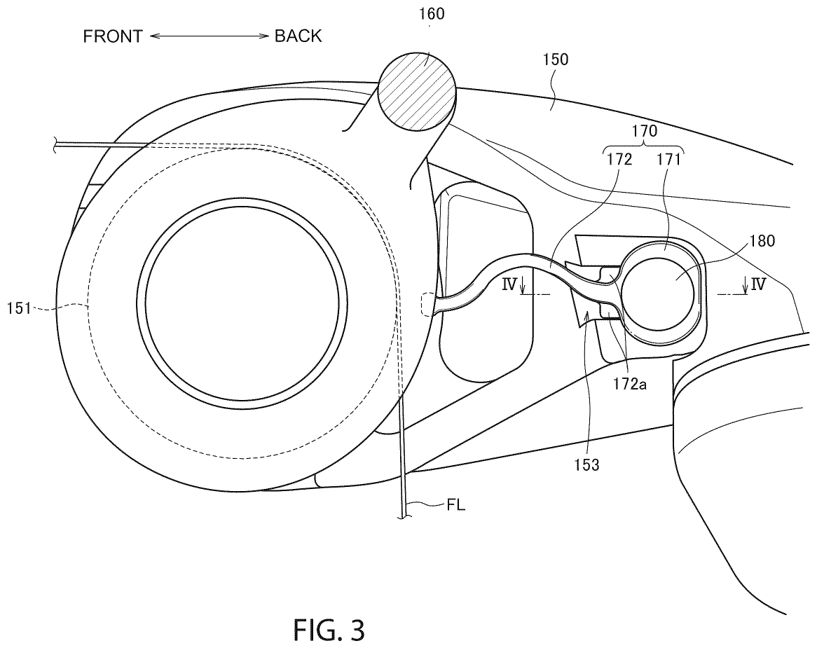

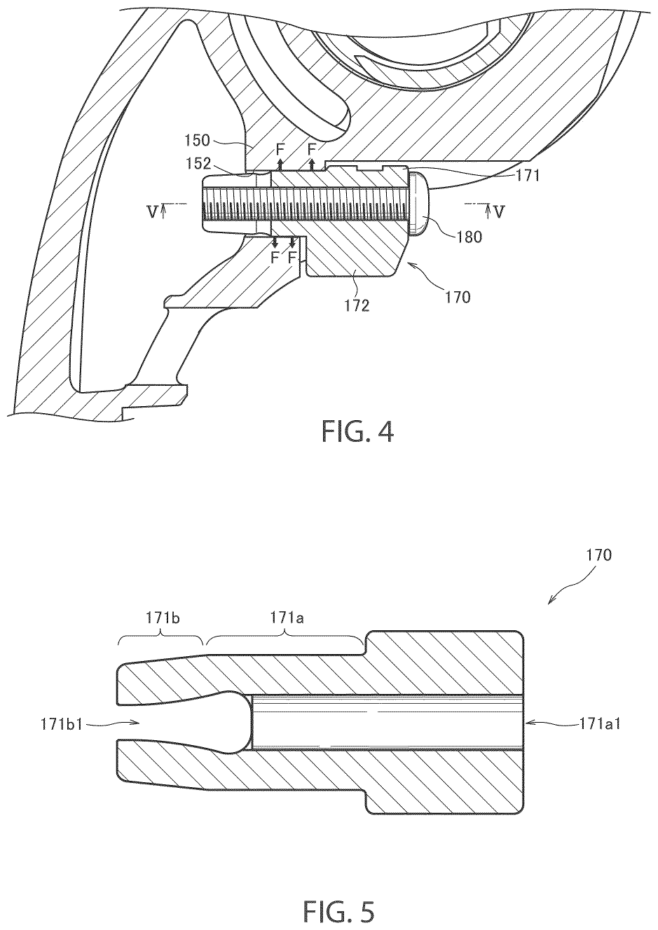

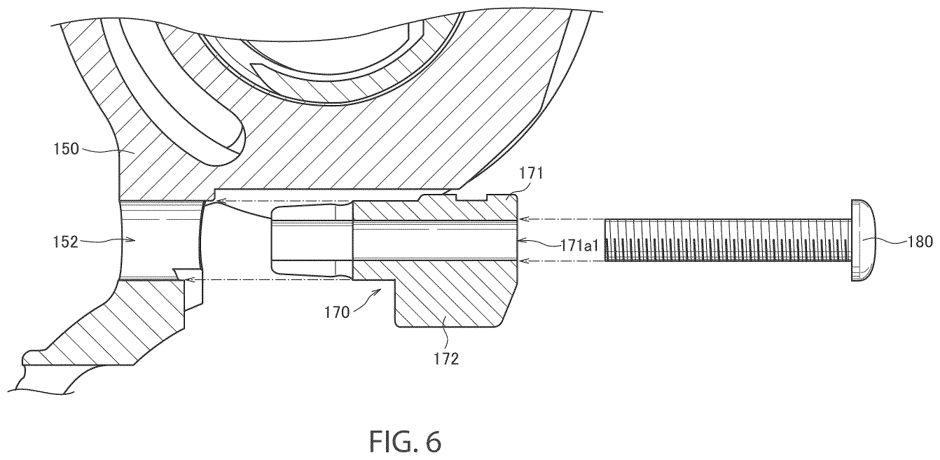

FIG. 3 is an enlarged view of the main part of the spinning reel 100 for fishing shown in FIG. 2 as viewed from the III direction, FIG. 4 is a cross-section diagram taken along line IV-IV in FIG. 3, FIG. 5 is a cross-section diagram of the line slack prevention member 170 taken along the V-V section of FIG. 4, and FIG. 6 is an exploded view of a fixing structure of the line slack prevention member 170 shown in FIG. 4.

### 2.1. Line Slack Prevention Member

The line slack prevention member 170 is provided on the bail support member 150 and is molded from a resin that has sufficient elasticity so as to be elastic deformable.

As shown in FIG. 3, the line slack prevention member 170 has a mounting portion 171 that is cylindrically shaft shape and is inserted into a mounting hole 152 (refer to FIG. 6) formed in the bail support member 150, and a fin portion 172 that extends outward from the mounting portion 171 in the radial direction of the mounting portion 171 and faces the line roller 151 at a distance.

As shown in FIG. 5, etc., the mounting portion 171 includes an abutting part 171a that abuts against the bail support member 150, and a diameter expanding part 171b that protrudes from the mounting hole 152 of the bail support member 150 and that is further on the distal end side than the abutting part 171a.

The abutting part 171a of the mounting portion 171 is cylindrical, and, as shown in FIG. 5, a through-hole 171al that extends in the longitudinal direction of the abutting part 171a is formed therein.

As shown in FIGS. 4 and 5, the diameter expanding part 171b of the mounting portion 171 has a cylindrical shape that is tapered toward the tip.

Furthermore, the diameter expanding part 171b is divided into two by a split groove 171b1.

Accordingly, the diameter expanding part 171b has a shape in which a tapered cylinder is divided into two by the split groove 171b1.

As shown in FIG. 3, the fin portion 172 is configured such that a positioning part 172a is formed in the vicinity of the mounting portion 171, the positioning part 172a being accommodated in a positioning groove 153 formed in the bail support member 150.

The thickness of the positioning part 172a of the fin portion 172 is approximately the same as the groove width of the positioning groove 153 of the bail support member 150.

Accordingly, as a result of the positioning part 172a of the line slack prevention member 170 being accommodated in the positioning groove 153 of the bail support member 150, rotation of the line slack prevention member 170 relative to the bail support member 150 is restricted.

Accordingly, when external force is applied to the tip of the fin portion 172, the line slack prevention member 170 does not rotate relative to the bail support member 150, and the fin portion 172 of the line slack prevention member 170 is elastically deformed relative to the mounting portion 171.

That is, the fin portion 172 of the line slack prevention member 170 is pivotable relative to the mounting portion 171.

### 2.2. Fixing Structure for Line Slack Prevention Member

As shown in FIGS. 3 and 4, the fixing structure includes the slack prevention member 170 and an expanding member 180. The expanding member 180 is inserted into the through-hole 171al of the mounting portion 171 of the line slack prevention member 170 and is provided as a fixing structure for fixing the line slack prevention member 170 configured in the manner described above to the bail support member 150.

The expanding member 180 is formed of a material (such as a metal) that is harder than the line slack prevention member 170.

As shown in FIGS. 4 to 6, male threads are formed on the outer circumferential surface of the expanding member 180.

That is, the expanding member 180 is configured as a so-called self-tapping screw, which, by being screwed into the through-hole 171a1 of the line slack prevention member 170, screws on while forming female threads on the inner circumferential surface of the through-hole 171al.

In addition, the outer diameter of the expanding member 180 is slightly larger than the inner diameter of the through-hole 171al of the line slack prevention member 170.

As a result, as shown in FIG. 6, when the expanding member 180 is screwed into the line slack prevention member 170 in a state in which the line slack prevention member 170 is attached to the bail support member 150, the diameter of the mounting portion 171 of the line slack prevention member 170 expands.

Accordingly, as shown in FIG. 4, the mounting portion 171 of the line slack prevention member 170 abuts against the mounting hole 152 of the bail support member 150, and a pressing force F caused by the expanding member 180 acts on the inner circumferential surface of the mounting hole 152 of the bail support member 150, so that the line slack prevention member 170 is fixed to the bail support member 150.

In addition, when the diameter of the split groove 171b, which divides the diameter expanding part 171b into two, expands due to the screwing of the expanding member 180 and the line slack prevention member 170, the diameter expanding part 171b of the line slack prevention member 170 also abuts against the mounting hole 152 of the bail support member 150, so that the line slack prevention member 170 is fixed in a state of being prevented from falling off by the bail support member 150.

### 3. Effects

According to the spinning reel 100 for fishing and the fixing structure for the line slack prevention member 170 according to the first embodiment of the present disclosure described above, the spinning reel 100 comprises the expanding member 180 that is inserted into the through-hole 171al provided on the mounting portion 171 of the line slack prevention member 170 to expand the diameter of the mounting portion 171 of the line slack prevention member 170, so that the mounting portion 171 of the line slack prevention member 170 expands in diameter and is pressed against the bail support member 150 to fix the line slack prevention member 170 to the bail support member 150. Therefore, the line slack prevention member 170 can be fixed to the bail support member 150 with a simple structure.

In addition, as a result of female threads, which screw onto the male threads of the expanding member 180, being formed on the inner circumferential surface of the mounting portion 171 of the line slack prevention member 170, when the expanding member 180 is screwed into the mounting portion 171 of the line slack prevention member 170, the expanding member 180 is inserted into the mounting portion 171 of the line slack prevention member 170. Therefore, when the expanding member 180 is inserted into the mounting portion 171 of the line slack prevention member 170, the expanding member 180 and the mounting portion 171 of the line slack prevention member 170 screw onto each other, making it difficult for the expanding member 180 to fall out of the line slack prevention member 170.

In addition, because the line slack prevention member 170 is made of resin and can be elastically deformed, when a knot N, etc., in the fishing line FL passes between the line roller 151 and the distal end portion of the fin portion 172 of the line slack prevention member 170, the fin portion 172 of the line slack prevention member 170 is pushed by the knot N, etc., and is able to freely swing together with the knot N, etc., in the direction in which the fishing line FL is guided, thereby suppressing damage of the line slack prevention member 170 caused by a knot N, etc., of the fishing line FL forcibly contacting the distal end portion of the fin portion 172 of the line slack prevention member 170.

### Embodiment 2

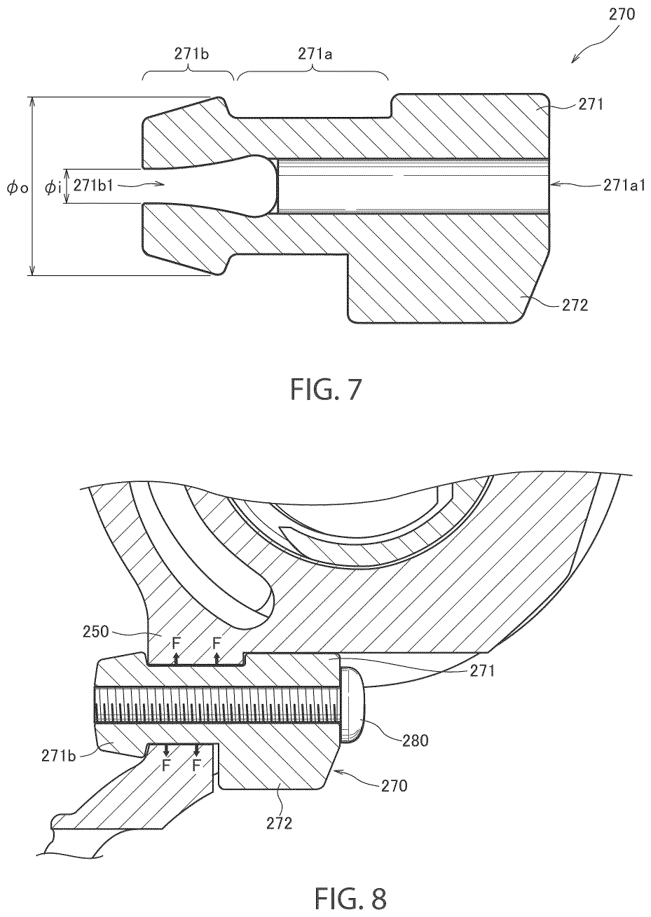

A spinning reel 200 for fishing according to a second embodiment of the present disclosure will be described next, with reference to FIGS. 7 and 8.

FIG. 7 is a cross-section diagram of a line slack prevention member 270 provided in the spinning reel 200 for fishing according to the second embodiment of the present disclosure, and FIG. 8 is a cross-section diagram explaining a fixing structure of the line slack prevention member 270 in the spinning reel 200 for fishing according to the second embodiment of the present disclosure.

The spinning reel 200 according to the second embodiment is obtained by changing the shape of the mounting portion of the line slack prevention member 170 in the spinning reel 100 of the first embodiment, and has many of the same elements as the spinning reel 100 of the first embodiment. Therefore detailed descriptions of the common features will be omitted, which will simply be assigned reference symbols in the 200 series with the same last two digits.

As shown in FIG. 7, a mounting portion 271 of the line slack prevention member 270 according to the second embodiment has an abutting part 271a that is inserted into and abuts against a mounting hole 252 of a bail support member 250, and a diameter expanding part 272b that has a larger diameter than the abutting part 271a, protrudes from the mounting hole 252 of the bail support member 250, and is further on the distal end side than the abutting part 271a.

The inner diameter of the diameter expanding part 272b decreases toward the tip, and the inner diameter φi at the tip of the diameter expanding part 272b is smaller than the outer diameter of an expanding member 280.

The outer diameter φo of the diameter expanding part 272b is larger than the inner diameter of the mounting hole 252 of the bail support member 250.

When the expanding member 280 is screwed into the line slack prevention member 270 when the line slack prevention member 270 is attached to the bail support member 250, the diameter of the mounting portion 271 of the line slack prevention member 270 expands.

Accordingly, as shown in FIG. 8, the mounting portion 271 of the line slack prevention member 270 abuts against the mounting hole 252 of the bail support member 250, so that the line slack prevention member 270 is fixed to the bail support member 250.

According to the spinning reel 200 for fishing and the fixing structure for the line slack prevention member 270 according to the second embodiment of the present disclosure described above, in addition to the effects exhibited by the spinning reel 100 for fishing and the fixing structure for the line slack prevention member 170 according to the first embodiment of the present disclosure, as a result of the mounting portion 271 of the line slack prevention member 270 having the abutting part 271a that is inserted into and abuts against the mounting hole 252 of the bail support member 250, and the diameter expanding part 271b that has a larger diameter than the abutting part 271a, protrudes from the mounting hole 252 of the bail support member 250, and is further on the distal end side than the abutting part 271a, the diameter expanding part 271b of the mounting portion 271 of the line slack prevention member 270 functions as a stopper, the diameter expanding part 271b being inserted into the mounting hole 252 of the bail support member 250 when having a reduced diameter due to elasticity of the diameter expanding part 272b itself. Therefore, it is unlikely that the expanding member 280 will fall out of the mounting portion 271 of the line slack prevention member 270.

In addition, even in the case of a large spinning reel for fishing intended for large fish in which the bail support part is formed of metal, etc., the line slack prevention member is not prevented from being attached/detached, and even if the expanding member is formed of a material (such as a metal) that is harder than the line slack prevention member, the expanding member does not come into direct contact with the bail support part, so that it is possible to prevent adhesion caused by electrolytic corrosion between different metals or corrosion due to salt water, etc.

### Modified Example

A spinning reel for fishing and a fixing structure for line slack prevention according to one embodiment of the present disclosure were described above, but the spinning reel for fishing and the fixing structure for line slack prevention of the present disclosure are not limited to the embodiment described above.

For example, in the above-mentioned embodiment, female threads are formed in the through-hole of the line slack prevention member and male threads are formed on the expanding member, but threads do not need to be formed on the expanding member or in the through-hole of the line slack prevention member as long as the expanding member can expand the diameter of the mounting portion of the line slack prevention member.

For example, in the above-mentioned embodiment, the handle is attached to the left side of the reel body, but the handle can be attached to the right side of the reel body.

What is claimed is:

1. A fixing structure for line slack prevention configured to be disposed on a bail support member of a spinning reel for fishing, the fixing structure comprising:
a line slack prevention member having a cylindrical mounting portion configured to be inserted into a mounting hole provided on the bail support member and a fin portion extending radially outward from the mounting portion; and
an expanding member configured to be inserted in a through-hole in the mounting portion to fix the mounting portion to the bail support member in an expanded state.

2. The fixing structure for line slack prevention according to claim 1, wherein
male threads are formed on the outer circumferential surface of the expanding member, and
female threads that correspond to the male threads of the expanding member are formed on the inner circumferential surface of the through-hole of the line slack prevention member.

3. The fixing structure for line slack prevention according to claim 1, wherein
the line slack prevention member is made of resin and is capable of being elastically deformed.

4. The fixing structure for line slack prevention according to claim 1, wherein
the mounting portion has an abutting part configured to be inserted into and abut against the mounting hole of the bail support member, and a diameter expanding part that has a larger diameter than the abutting part, that protrudes from the mounting hole of the bail support member, and that is further on a distal end side than the abutting part.

5. A spinning reel for fishing, comprising:
a spool configured to wind a fishing line;
a rotor having a rotor arm configured to wind the fishing line onto the spool;
a bail support member configured to turn with free up-and-down movement relative to the rotor arm of the rotor;
a line roller disposed on the bail support member and configured to guide the fishing line to the spool;
a line slack prevention member having a cylindrical mounting portion configured to be inserted into a mounting hole provided on the bail support member and a fin portion extending radially outward from the mounting portion and facing the line roller; and
an expanding member configured to be inserted into a through-hole in the mounting portion of the line slack prevention member to expand the diameter of the mounting portion of the line slack prevention member to fix the line slack prevention member to the bail support member.
